(19) United States
(12) Patent Application Publication
(10) Pub. No.: US 2025/0392152 A1
(43) Pub. Date: Dec. 25, 2025

(54) POWER BOOST CHARGING SYSTEM AND METHOD

(71) Applicant: Cypress Semiconductor Corporation, San Jose, CA (US)

(72) Inventors: Bhargav Teja PALETI, Bangalore (IN); Kailas NARAYANA IYER, Bangalore (IN)

(73) Assignee: Cypress Semiconductor Corporation, San Jose, CA (US)

(21) Appl. No.: 18/750,157

(22) Filed: Jun. 21, 2024

(51) Int. Cl. H02J 7/00

(52) U.S. Cl. CPC H02J 7/007192; H02J 7/00034; H02J 2207/30

(57) ABSTRACT

A method includes detecting a connection of a device to a USB Type-C Power Delivery (USB-C/PD) port, generating a base power delivery profile for providing power to the device through the USB-C/PD port according to a base maximum power level, entering a power boost mode, generating a power boost delivery profile in the power boost mode according to a boost maximum power level greater than the base maximum power level, delivering power to the device through the USB-C/PD port according to a first contract negotiated based on the power boost delivery profile for a predetermined time period, exiting the power boost mode responsive to expiration of the predetermined time period, and delivering power to the device through the USB-C/PD port according to a second contract negotiated based on the base power delivery profile after exiting the power boost mode, wherein the second contract is compliant with a USB-PD specification.

### BACKGROUND

Various electronic devices (e.g., such as smartphones, tablets, notebook computers, laptop computers, hubs, chargers, adapters, etc.) are configured to transfer power through Universal Serial Bus (USB) connectors according to USB power delivery protocols defined in various revisions of the USB Power Delivery (USB-PD) specification.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In an embodiment of the techniques presented herein, a method comprises detecting a connection of a device to a USB Type-C Power Delivery (USB-C/PD) port, generating a base power delivery profile for providing power to the device through the USB-C/PD port according to a base maximum power level, entering a power boost mode, generating a power boost delivery profile in the power boost mode according to a boost maximum power level greater than the base maximum power level, delivering power to the device through the USB-C/PD port according to a first contract negotiated based on the power boost delivery profile for a predetermined time period, exiting the power boost mode responsive to expiration of the predetermined time period, and delivering power to the device through the USB-C/PD port according to a second contract negotiated based on the base power delivery profile after exiting the power boost mode, wherein the second contract is compliant with a USB-PD specification.

In an embodiment of the techniques presented herein, a system comprises a USB Type-C Power Delivery (USB-C/PD) port, a controller operatively coupled to the USB-C/PD port, wherein the controller is configured to detect a connection of a device to the USB-C/PD port, generate a base power delivery profile for providing power to the device through the USB-C/PD port according to a base maximum power level, enter a power boost mode, generate a power boost delivery profile in the power boost mode according to a boost maximum power level greater than the base maximum power level, deliver power to the device through the USB-C/PD port according to a first contract negotiated based on the power boost delivery profile for a predetermined time period, exit the power boost mode responsive to expiration of the predetermined time period, and deliver power to the device through the USB-C/PD port according to a second contract negotiated based on the base power delivery profile after exiting the power boost mode, wherein the second contract is compliant with a USB-PD specification.

In an embodiment of the techniques presented herein, a method comprises detecting a connection of a device to a USB Type-C Power Delivery (USB-C/PD) port, generating a base power delivery profile for providing power to the device through the USB-C/PD port according to a base maximum power level, entering a power boost mode, generating a power boost delivery profile in the power boost mode according to a boost maximum power level greater than the base maximum power level, delivering power to the device through the USB-C/PD port according to a first contract negotiated based on the power boost delivery profile, exiting the power boost mode responsive to at least one of an expiration of a predetermined time period, a temperature of a charging system including the USB-C/PD port exceeding a predetermined temperature, or receiving a power boost mode termination message from the device, setting a boost mode inhibit flag after exiting the power boost mode, delivering power to the device through the USB-C/PD port according to a second contract negotiated based on the base power delivery profile after exiting the power boost mode, and clearing the boost mode inhibit flag responsive to detecting a disconnection of the device from the USB-C/PD port, wherein the second contract is compliant with a USB-PD specification.

In an embodiment of the techniques presented herein, a system comprises means for detecting a connection of a device to a USB Type-C Power Delivery (USB-C/PD) port, means for generating a base power delivery profile for providing power to the device through the USB-C/PD port according to a base maximum power level, means for entering a power boost mode, means for generating a power boost delivery profile in the power boost mode according to a boost maximum power level greater than the base maximum power level, means for delivering power to the device through the USB-C/PD port according to a first contract negotiated based on the power boost delivery profile for a predetermined time period, means for exiting the power boost mode responsive to expiration of the predetermined time period, and means for delivering power to the device through the USB-C/PD port according to a second contract negotiated based on the base power delivery profile after exiting the power boost mode, wherein the second contract is compliant with a USB-PD specification.

In an embodiment of the techniques presented herein, a system comprises means for detecting a connection of a device to a USB Type-C Power Delivery (USB-C/PD) port, means for generating a base power delivery profile for providing power to the device through the USB-C/PD port according to a base maximum power level, means for entering a power boost mode, means for generating a power boost delivery profile in the power boost mode according to a boost maximum power level greater than the base maximum power level, means for delivering power to the device through the USB-C/PD port according to a first contract negotiated based on the power boost delivery profile, means for exiting the power boost mode responsive to at least one of an expiration of a predetermined time period, a temperature of a charging system including the USB-C/PD port exceeding a predetermined temperature, or receiving a power boost mode termination message from the device, means for setting a boost mode inhibit flag after exiting the power boost mode, means for delivering power to the device through the USB-C/PD port according to a second contract negotiated based on the base power delivery profile after exiting the power boost mode, and means for clearing the boost mode inhibit flag responsive to detecting a disconnection of the device from the USB-C/PD port, wherein the second contract is compliant with a USB-PD specification.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a block diagram of a charging system, in accordance with some embodiments.

FIGS. 2-5 are flowcharts illustrating methods of operating a charging system to support power boost mode, in accordance with some embodiments.

FIG. 6 illustrates an exemplary embodiment of a system, in accordance with some embodiments.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

It is to be understood that the following description of embodiments is not to be taken in a limiting sense. The scope of the present disclosure is not intended to be limited by the embodiments described hereinafter or by the drawings, which are taken to be illustrative only. The drawings are to be regarded as being schematic representations and elements illustrated in the drawings are not necessarily shown to scale. Rather, the various elements are represented such that their function and general purpose become apparent to a person skilled in the art.

All numerical values within the detailed description and the claims herein are modified by “about” or “approximately” the indicated value, and take into account experimental error and variations that would be expected by a person having ordinary skill in the art.

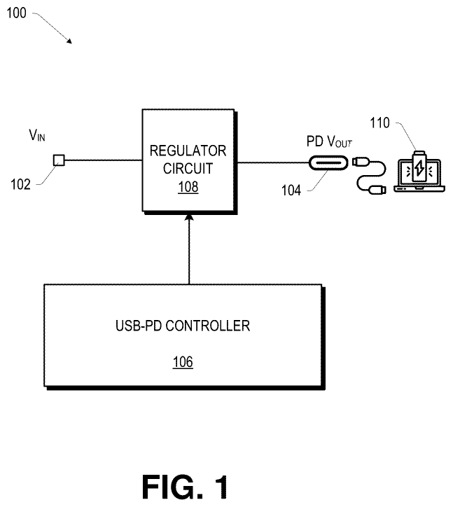

FIG. 1 is a block diagram illustrating a charging system 100 including a power input port 102, at least one USB Type-C Power Delivery (USB-C/PD) port 104, and a USB power delivery (USB-PD) controller 106 configured to control a regulator circuit 108 to provide an output voltage, PD VOUT, at the USB-C/PD port 104 to deliver power to power to a PD device 110, such as a laptop, a smart phone, a tablet, or some other device, typically including a rechargeable battery. The power input port 102 may be connected to an alternating current (AC) power supply, such as a wall adaptor that rectifies an AC voltage to generate a direct current (DC) voltage, or the power input port 102 may be connected directly to a DC power supply, such as a vehicle DC bus.

In some embodiments, the regulator circuit 108 is integrated into the USB-PD controller 106. The USB-PD controller 106 controls the regulator circuit 108 to regulate current, voltage, or both current and voltage. The USB-PD controller 106 may control the regulator circuit 108 in a buck mode to reduce the voltage at the power input port 102 or a boost mode to increase the voltage at the power input port 102. In a current control mode, the USB-PD controller 106 may operate the regulator circuit 108 to limit the current provided to the USB-C/PD port 104. In some embodiments, the regulator circuit 108 comprises a bypass circuit to provide the VIN voltage directly to the USB-C/PD port 104. Alternatively, the USB-PD controller 106 may operate the regulator circuit 108 in a unity gain mode.

In some embodiments, the USB-PD controller 106 may be compliant with a specific revision and/or version of the USB-PD specification. The USB-PD specification defines a standard protocol designed to enable the maximum functionality of USB-enabled devices by providing more flexible power delivery along with data communications over a single USB Type-C cable through USB Type-C ports. The USB-PD specification also describes the architecture, protocols, power supply behavior, parameters, and cabling necessary for managing power delivery over USB Type-C cables at up to 100 W of power or higher (e.g., up to 240 W) in the case of Extended Power Range (EPR). According to the USB-PD specification, devices with USB Type-C ports (e.g., USB-enabled devices) may negotiate for more current and/or higher or lower voltages over a USB Type-C cable than are supported in older USB specifications (e.g., the USB 2.0 Specification, the USB Battery Charging Specification Rev. 1.1/1.2, etc.). For example, the USB-PD specification defines the requirements for a power delivery contract (PD contract) that can be negotiated between a pair of USB-enabled devices. The PD contract can specify both the power level and the direction of power transfer that can be accommodated by both devices, and the PD contract can be dynamically re-negotiated (e.g., without device un-plugging) upon request by either device and/or in response to various events and conditions, such as power role swap, data role swap, hard reset, failure of the power source, etc. According to the USB-PD specification, an electronic device is typically configured to deliver power to another device through a power path configured on a USB VBUS line. In some embodiments, a USB-PD power source can be configured to draw power from a direct current (DC) power source and can include a direct current-to-direct current (DC-DC) converter. In other embodiments, a USB-PD power source may be configured to draw power from an alternating current (AC) power adapter or from another AC source (e.g., a wall socket).

In a power delivery mode, the USB-PD controller 106 negotiates a power delivery (PD) contract with the PD device 110 for a requested PD VOUT and maximum current. The USB-PD controller 106 advertises a power delivery profile (PDP) specifying available voltage and current levels (e.g., in accordance with a USB-PD specification). The PD device 110 selects a power delivery option based on its charging requirements. In some embodiments, a base PDP is determined based on a base maximum power level that depends on the current and temperature ratings of the components in the charging system 100, such as the components in the regulator circuit 108, the cooling provided to the charging system 100, or other factors. The base PDP represents conditions under which the charging system can operate without undue stress or overheating.

In some embodiments, according to the techniques described herein, the USB-PD controller 106 supports a power boost mode (PBM) where, for a predetermined time period, the power delivered can be based on a boost maximum power level that is greater than the base maximum power associated with the base PDP to support rapid charging of the PD device 110. According to the techniques described herein, the PBM mode is provided in addition to various charging modes described and/or required by a USB-PD specification to allow for better charging efficiency (e.g., in terms of power usage and duration of charging) without the cost of additional hardware components. For example limiting the time period for the power boost mode allows a higher level of power to be provided without requiring higher capacity, more costly components in the charging system 100 that would be able to support indefinite power delivery at the higher level. In some embodiments, the USB-PD controller 106 only allows a power boost mode session once per connection with the PD device 110. The USB-PD controller 106 may negotiate the power boost mode with the PD device 110 if the PD device 110 is equipped to request power boost mode. Alternatively, the USB-PD controller 106 may initiate power boost mode independently based on the temperature characteristics of the charging system 100 or based on the behavior of the PD device 110. In some embodiments, power boost mode may be terminated after expiration of the predetermined time period, responsive to a request from the PD device 110, or based on the temperature of the charging system 100.

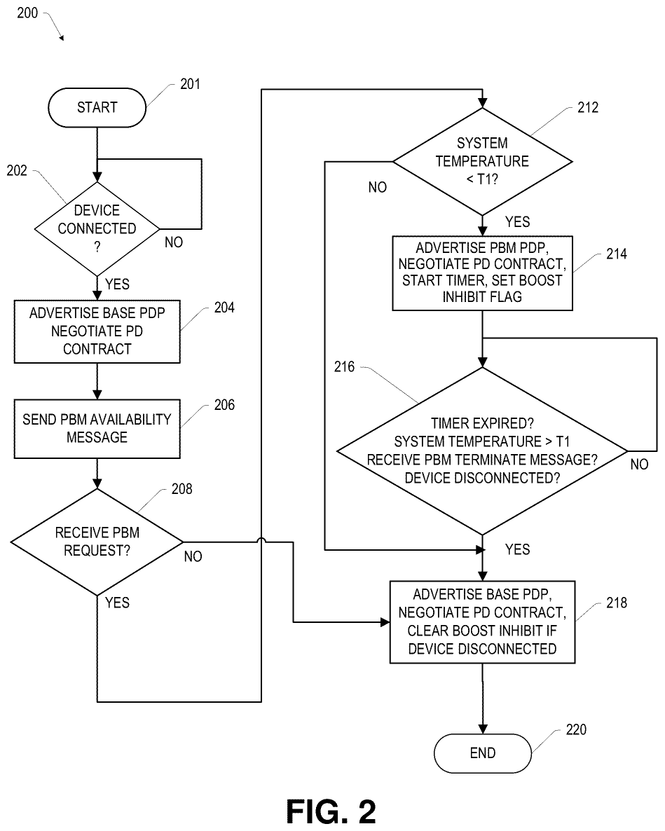

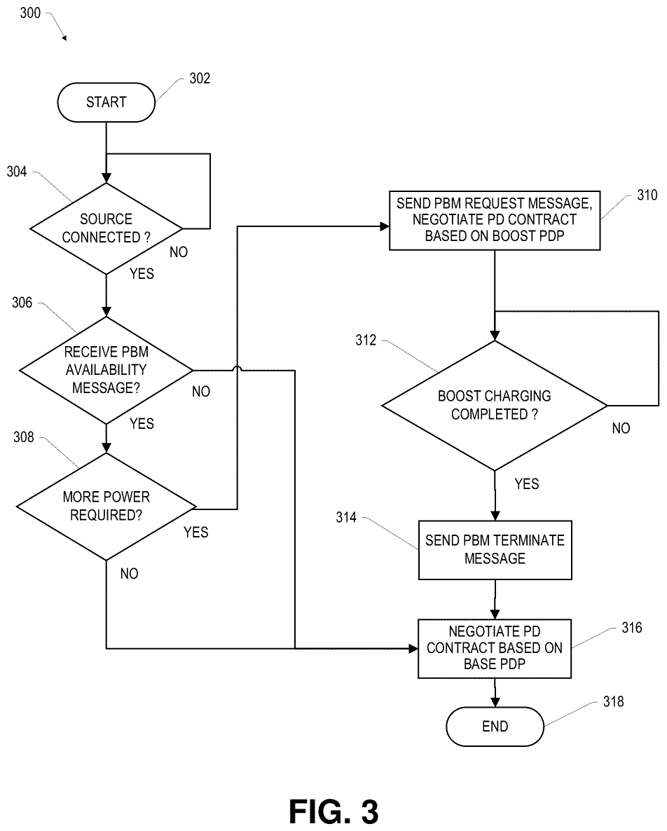

FIGS. 2-5 are flowcharts illustrating methods 200, 300, 400, 500 of operating the charging system 100 to support power boost mode (PBM), in accordance with some embodiments. FIGS. 2 and 3 show the method 200 performed by the USB-PD controller 106 and the method 300 performed by the PD device 110, respectively, in an embodiment where the USB-PD controller 106 and the PD device 110 are capable of exchanging message to control the power boost mode (PBM). In some embodiments, unstructured vendor defined messages (UVDMs) or vender defined messages (VDMs) may be used according to a USB-PD specification to exchange boost mode messages. Referring to FIG. 2, the method 200 starts at 201. At 202, the USB-PD controller 106 determines if a device, such as the PD device 110, is connected at the USB-C/PD port 104. If the PD device 110 is connected at 202, the USB-PD controller 106 advertises a base PDP to the PD device at 204. An example base PDP is:

```
20 V @ 3.25 A
15 V @ 3 A
  9 V @ 3 A
  5 V @ 3 A
```

At 206, the USB-PD controller 106 sends a power boost support message to the PD device 110 indicating that power boost mode is supported. The PD device 110 has the option to negotiate a power delivery contract with the USB-PD controller 106 based on the base PDP at 204, or the PD device 110 can request PBM by sending a PBM request message if the PD device 110 determines that a higher power level would be beneficial based on its battery state. Responsive to the USB-PD controller 106 receiving a PBM request message at 208, the USB-PD controller 106 determines if the temperature of the charging system 100 is less than a threshold, T1, at 212. If the temperature of the charging system 100 is less than the threshold, T1, the USB-PD controller 106 advertises a PBM PDP, negotiates a PD contract based on the PBM PDP, and starts a timer at 214. In some embodiments, the USB-PD controller 106 only allows one PBM session per connection with the PD device 110. The USB-PD controller 106 may set a boost mode inhibit flag when the PBM session is advertised at 214.

An example PBM PDP is:

```
20 V @ 5 A
15 V @ 3.25 A
  9 V @ 3.25 A
  5 V @ 3.25 A
```

At 216, the USB-PD controller 106 identifies PBM termination conditions, such as the expiration of the timer, the system temperature of the charging system exceeding the threshold, T1, receiving a PBM termination message from the PD device 110, or detecting a disconnection of the PD device 110 from the USB-C/PD port 104. The timer provides a limited time period for the PBM to avoid overheating or stressing the components of the charging system 100. In some embodiments, the PD device 110 may send a PBM termination message prior to the predetermined time period elapsing if the PD device 110 determines an adequate charge level has been reached. The temperature threshold, T1, provides protection for the charging system 100. After terminating PBM, the USB-PD controller 106 advertises the base PDP and allows negotiation of an updated PD contract at 218. In some embodiments, the USB-PD controller 106 may clear the boost mode inhibit flag at 218 if a disconnection of the PD device 110 is detected as the termination condition at 216.

If the system temperature is not less than the threshold, T1, at 212, the USB-PD controller 106 continues to advertise the PBM PDP and negotiates a PD contract based on the PBM PDP at 218. The method 200 terminates at 220.

Referring to FIG. 3, the method 300 implemented by the PD device 110 starts at 302. At 304, the PD device 110 detects a power source connection with the charging system 100 at 304. The PD device 110 determines if the PBM support message (sent at 206 of FIG. 2) is received at 306. At 308, the PD device 110 determines if additional power is required than specified in the base PDP based on the charging state of the battery in the PD device 110. If additional power is required at 308, the PD device 110 sends the PBM request message at 310. The PD device 110 negotiates a PD contract based on the PBM PDP at 310. Responsive to the PD device 110 determining the boost charging is completed, for example, based on the charging state of the battery in the PD device 110, at 312, the PD device 110 sends a PBM terminate message at 314. At 316, the PD device 110 negotiates a PD contract based on the base PDP at 316 after termination of the PBM by the USB-PD controller 106 (at 216 and 218 of FIG. 2). If additional power is not required at 308, the PD device 110 negotiates a PD contract based on the base PDP at 316. The method 300 terminates at 318.

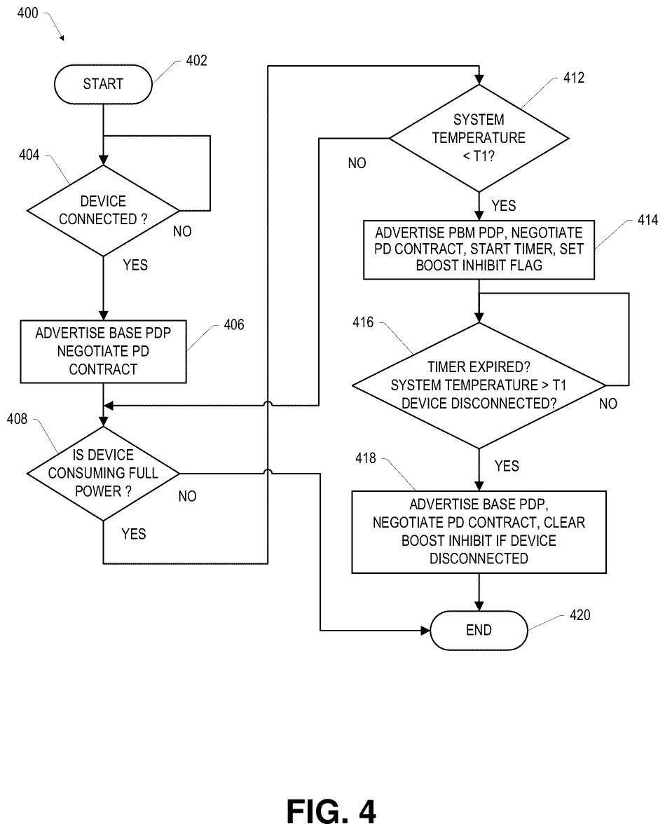

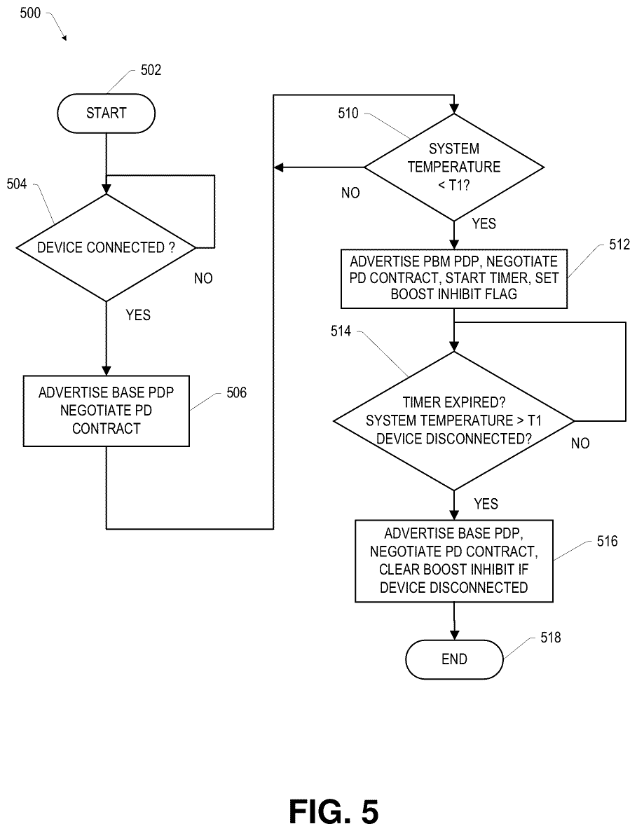

FIGS. 4 and 5 show methods 400 and 500 performed by the USB-PD controller 106 in embodiments where the PD device 110 is not capable of exchanging messages to control the power boost mode (PBM). Referring to FIG. 4, the method 400 starts at 402. At 404, the USB-PD controller 106 determines if a device, such as the PD device 110, is connected at the USB-C/PD port 104. If the PD device 110 is connected at 404, the USB-PD controller 106 advertises a base PDP to the PD device at 406. An example base PDP is:

```
20 V @ 3.25 A
15 V @ 3 A
  9 V @ 3 A
  5 V @ 3 A
```

At 408, the USB-PD controller 106 determines if the PD contract specifies a full power profile, such as the highest power delivery profile (20V @3.25 A) listed above in the base PDP. If a full power profile is selected at 408, the USB-PD controller 106 determines if the temperature of the charging system 100 is less than a threshold, T1, at 412. If the charging system 100 temperature is less than a threshold, T1, at 412, the USB-PD controller 106 advertises a PBM PDP, negotiates a PD contract based on the PBM PDP, and starts a timer at 414. In some embodiments, the USB-PD controller 106 only allows one PBM session per connection with the PD device 110. The USB-PD controller 106 may set a boost mode inhibit flag when the PBM session is advertised at 414.

An example PBM PDP is:

```
20 V @ 5 A
15 V @ 3.25 A
  9 V @ 3.25 A
  5 V @ 3.25 A
```

At 416, the USB-PD controller 106 identifies PBM termination conditions, such as the expiration of the timer, the system temperature of the charging system 100 exceeding a threshold, T1, or detecting a disconnection of the PD device 110 from the USB-C/PD port 104. The timer provides a limited time period for the PBM to avoid overheating or stressing the components of the charging system 100. The temperature threshold, T1, provides protection for the charging system 100. After terminating PBM, the USB-PD controller 106 advertises the base PDP and allows negotiation of an updated PD contract at 418. In some embodiments, the USB-PD controller 106 may clear the boost mode inhibit flag at 418 if a disconnection of the PD device 110 is detected as the termination condition at 416.

If the temperature of the charging system 100 is not less than the threshold, T1, at 412, the USB-PD controller 106 continues power delivery based on the base PDP and returns to 408. The USB-PD controller 106 may check the system temperature after a predetermined time interval to determine if PBM can be offered. The method 400 terminates at 420.

Referring to FIG. 5, the method 500 starts at 502. At 504, the USB-PD controller 106 determines if a device, such as the PD device 110, is connected at the USB-C/PD port 104. If the PD device 110 is connected at 504, the USB-PD controller 106 advertises a base PDP to the PD device at 506. An example base PDP is:

```
20 V @ 3.25 A
15 V @ 3 A
  9 V @ 3 A
  5 V @ 3 A
```

At 510, the USB-PD controller 106 determines if the temperature of the charging system 100 is less than a threshold, T1. If the temperature of the charging system 100 is less than the threshold, T1, at 510, the USB-PD controller 106 advertises a PBM PDP, negotiates a PD contract based on the PBM PDP, and starts a timer at 512. In some embodiments, the USB-PD controller 106 only allows one PBM session per connection with the PD device 110. The USB-PD controller 106 may set a boost mode inhibit flag when the PBM session is advertised at 512.

An example PBM PDP is:

```
20 V @ 5 A
15 V @ 3.25 A
  9 V @ 3.25 A
  5 V @ 3.25 A
```

At 514, the USB-PD controller 106 identifies PBM termination conditions, such as the expiration of the timer, the system temperature of the charging system 100 exceeding the threshold, T1, or detecting a disconnection of the PD device 110 from the USB-C/PD port 104. The timer provides a limited time period for the PBM to avoid overheating or stressing the components of the charging system 100. The temperature threshold, T1, provides protection for the charging system 100. After terminating PBM, the USB-PD controller 106 advertises the base PDP and allows negotiation of an updated PD contract at 516. In some embodiments, the USB-PD controller 106 may clear the boost mode inhibit flag at 516 if a disconnection of the PD device 110 is detected as the termination condition at 514.

If the system temperature is not less than the threshold, T1, at 510, the USB-PD controller 106 continues power delivery based on the base PDP and returns to 506. The USB-PD controller 106 may check the system temperature after a predetermined time interval to determine if PBM can be offered. The method 500 terminates at 518.

Providing power boost mode for a limited time period allows a faster charging mode to be offered without requiring more expensive, higher capacity components in the charging system 100. The time limit mitigates stress on the charging system 100. The PBM session may be limited to only once per connection cycle.

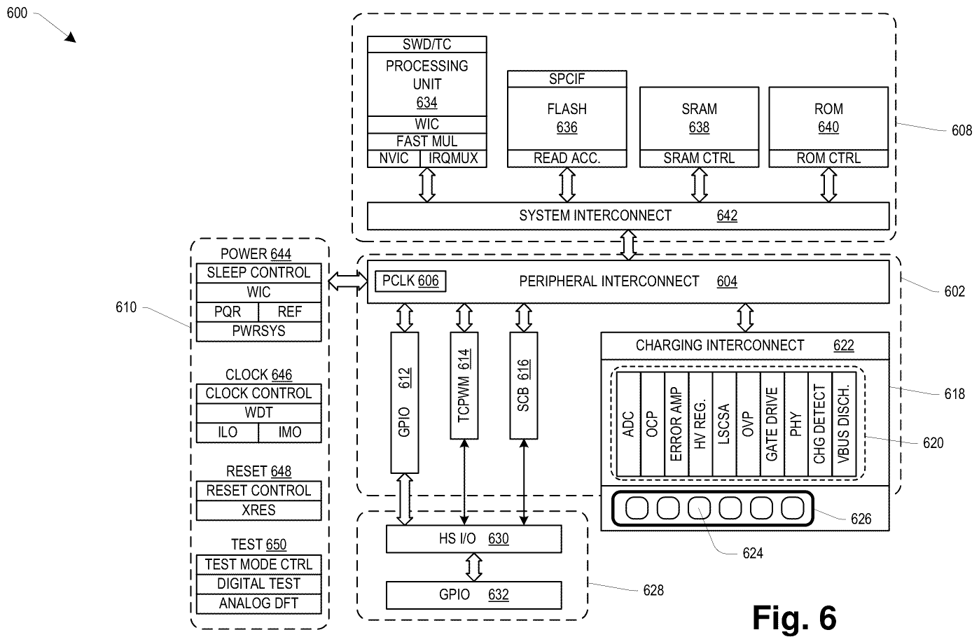

FIG. 6 is a block diagram illustrating a system 600, in accordance with some embodiments. The system 600 may be used to implement the USB-PD controller 106. In some embodiments, the system 600 may be used to implement a corresponding USB-PD controller that is configured within the PD device 110 to facilitate USB-PD communications (e.g., by using UVDMs or VDMs) with a power delivery controller in accordance with a USB-PD specification. The system 600 may include a peripheral subsystem 602 that includes a number of components for use in wireless charging or USB power delivery. The peripheral subsystem 602 may include a peripheral interconnect 604 including a peripheral clock module (PCLK) 606 for providing clock signals to the various components of the peripheral subsystem 602. The peripheral interconnect 604 may be a peripheral bus, such as a single level or Multi-level Advanced High Performance Bus (AHB), and can provide a data and control interface between the peripheral subsystem 602, a CPU subsystem 608, and system resources 610. The peripheral interconnect 604 may include controller circuitry, such as direct memory access (DMA) controllers, which may be programmed to transfer data between peripheral blocks without input from the CPU subsystem 608, without control of the CPU subsystem 608, or without stressing the same transfer.

The peripheral interconnect 604 may be used to couple the peripheral subsystem 602 components to other components of the system 600. A number of general purpose inputs/outputs (GPIOs) 612 may be coupled to the peripheral interconnect 604 for sending and receiving signals. The GPIOs 612 may include circuitry configured to implement various functions such as pull-up, pull-down, input threshold selection, input and output buffer enable/disable, single multiplexing, and so on. Other functions can also be implemented by the GPIOs 612. One or more timer/counter/pulse width modulators (TCPWM) 614 may also be coupled to the peripheral interconnect and may include circuitry to implement timing circuits (timers), counters, pulse width modulators (PWMs), decoders, and other digital functions associated with I/O signals work and can provide digital signals for system components of the system 600. The peripheral subsystem 602 may also include one or more Serial Communication Blocks (SCBs) 616 for implementing serial communication interfaces such as I2C, Serial Peripheral Interface (SPI), Universal Asynchronous Receiver/Transmitter (UART), Controller Area Network (CAN), CXPI (Clock Extension Peripheral Interface), etc.

The peripheral subsystem 602 may include a charging subsystem 618 (e.g., for USB-PD or wireless charging) coupled to the peripheral interconnect 604 and including a set of modules 620. The modules 620 may be coupled to the peripheral interconnect 604 by a charging interconnect 622. The modules 620 may include: an analog-to-digital converter (ADC) module for converting various analog signals into digital signals; an error amplifier (AMP) that regulates the output voltage on the VBUS line by PD contract; a high voltage (HV) regulator for converting the power source voltage to a precise voltage (such as 3.5-5V) to power the system 600; a low-side current sense amplifier (LSCSA) to accurately measure load current, an over-voltage protection (OVP) module and an over-current protection (OCP) module to provide over-current and over-voltage protection on the VBUS line with configurable thresholds and response times; one or more gate drivers for external power field effect transistors (FETs) (e.g., in the regulator circuit 108) in provider and consumer configurations; and a communications channel PHY module to support communications on a communication channel line (e.g., a USB Type-C communications channel (CC) line). The modules 620 may also include a charger detection module to determine if charging circuitry is present and coupled to the system 600 and a VBUS discharge module to control the discharge of voltage on the VBUS. The VBUS discharge module may be configured to couple to a power source node on the VBUS line or to an output (power sink) node on the VBUS line and adjust the voltage on the VBUS line to the desired voltage level (i.e., the voltage level specified in the contract negotiated voltage level). The power delivery subsystem 618 may also include pads 624 for external connections and Electrostatic Discharge (ESD) suppression circuitry 626. The modules 620 may also include a communication module for retrieving and transmitting information, such as control signals.

The GPIOs 612, the TCPWM 614, and the SCB 616 may be coupled to an input/output (I/O) subsystem 628, which may include a high-speed (HS) I/O matrix 630 connected to a number of GPIOs 632. The GPIOs 612, the TCPWM 614, and the SCB 616 may be coupled to the GPIOs 632 through the HS-I/O matrix 630.

The central processing unit (CPU) subsystem 608 is provided for processing instructions, storing program information and data. The CPU subsystem 608 may include one or more processing units 634 for executing instructions and reading from and writing to memory locations from a number of memories. The processing unit 634 may be a processor suitable for operation in an integrated circuit (IC) or system-on-chip (SOC) device. In some embodiments, the processing unit 634 may be optimized for low power operation with extensive clock gating. In this embodiment, different internal control circuits can be implemented for processing unit operation in different power states. For example, the processing unit 634 may include a single wire debug (SWD) module, a terminal count (TC) module, a wake-up interrupt controller (WIC) configured to wake up the processing unit from a sleep state, which may shut down power when the IC or SOC is in is in a sleep state, a fast multiplier, a nested vector interrupt controller (NVIC), and an interrupt multiplexer (IRQMUX). The CPU subsystem 608 may include one or more memories, including a flash memory 636, a static random access memory (SRAM) 638, and a read only memory (ROM) 640. The flash memory 636 may be non-volatile memory (NAND flash, NOR flash, etc.) configured to store data, programs, and/or other firmware instructions. The flash memory 636 may include system performance controller interface (SPCIF) registers and a read accelerator and, by being integrated into the CPU subsystem 608, improve access times. The SRAM 638 may be volatile memory configured to store data and firmware instructions accessible by the processing unit 634. The ROM 640 may be configured to store boot routines, configuration parameters, and other firmware parameters and settings that do not change during operation of the system 600. The SRAM 638 and the ROM 640 may have associated control circuitry. The processing unit 634 and the memory modules 636, 638, 640 may be coupled to a system interconnect 642 to route signals to and from the various components of the CPU subsystem 608 to other blocks or modules of the system 600. The system interconnect 642 can be implemented as a system bus, such as a single-level or multi-level AHB. The system interconnect 642 may be configured as an interface to couple the various components of the CPU subsystem 608 together. The system interconnect 642 may be coupled to the peripheral interconnect 604 to provide signal paths between the CPU subsystem 608 and components of the peripheral subsystem 602.

The system resources 610 may include a power module 644, a clock module 646, a reset module 648, and a test module 660. The power module 644 may include a sleep control module, a wake-up interrupt control (WIC) module, a power-on-reset (POR) module, a number of voltage references (REF), and a PWRSYS module. In some embodiments, the power module 644 may include circuitry that allows the system 600 to draw power from and/or provide power to external sources at different voltage and/or current levels and control operation in different power states, such as active, low power, or sleep. In various embodiments, more power states may be implemented as the system 600 throttles operation to achieve a desired power consumption or power output. The clock module 646 may include a clock control module, a watchdog timer (WDT), an internal low-speed oscillator (ILO), and an internal main oscillator (IMO). The reset module 648 may include a reset control module and an external reset module (XRES module). The test module 650 may include a module to control and enter a test mode, as well as test control modules for analog and digital functions (digital test and analog DFT).

The system 600 may be implemented as an IC controller (e.g., such as the USB-PD controller 106) in a monolithic (e.g., single) semiconductor die. In other embodiments, different parts or modules of the system 600 may be implemented on different semiconductor dies. For example, the memory modules 636, 638, 640 of the CPU subsystem 608 may be on-chip or off-chip. In still other embodiments, circuitry with separate dies can be packaged in a single “chip” or remain separate and arranged on a circuit board (or in a USB cable connector) as separate elements.

The system 600 can be implemented in a number of application contexts. In any application context, an electronic device may have an IC controller or SOC implementation embodied by the system 600 arranged and configured to perform operations according to the techniques described herein (e.g., such as the USB-PD controller 106) in the context of a USB-PD specification. In one embodiment, the system 600 may be arranged and configured in a USB-enabled peripheral device, such as a personal computer (PC) power adapter for a laptop, a notebook computer, or some other device. In an embodiment, the system 600 may be housed in a power adapter for a mobile electronic device (e.g. a smartphone, a tablet, etc.). In an embodiment, the system 600 may be arranged and configured in a car charger configured to provide power via a wireless charging pad and USB Type-A and/or Type-C port(s). In an embodiment, the system 600 may be arranged and configured in a power bank that can be charged via a USB Type-A and/or Type-C port and then provide power (e.g., wirelessly or via a USB port) to another electronic device.

It should be understood that a system, such as the system 600, implemented on or as an IC controller, can be placed in various applications that vary in terms of the type of power source used and the direction in which power is supplied. For example, in the case of a car charger, the power source is a car battery that provides DC power, while in the case of a mobile power adapter, the power source is an AC wall outlet. Further, in the case of a PC power adapter, the flow of power input is from a provider device to a consumer device, while in the case of a power bank, the flow of power input can be in either direction, depending on whether the power bank is operating as a power provider (e.g., to power another device) or as a power consumer (e.g., to allow itself to be charged). For these reasons, the various applications of the system 600 should be considered in an illustrative rather than a limiting sense.

In an embodiment of the techniques presented herein, a method comprises detecting a connection of a device to a USB Type-C Power Delivery (USB-C/PD) port, generating a base power delivery profile for providing power to the device through the USB-C/PD port according to a base maximum power level, entering a power boost mode, generating a power boost delivery profile in the power boost mode according to a boost maximum power level greater than the base maximum power level, delivering power to the device through the USB-C/PD port according to a first contract negotiated based on the power boost delivery profile for a predetermined time period, exiting the power boost mode responsive to expiration of the predetermined time period, and delivering power to the device through the USB-C/PD port according to a second contract negotiated based on the base power delivery profile after exiting the power boost mode, wherein the second contract is compliant with a USB-PD specification.

In an embodiment of the techniques presented herein, the method further comprises setting a boost mode inhibit flag after exiting the power boost mode, and clearing the boost mode inhibit flag responsive to detecting a disconnection of the device from the USB-C/PD port.

In an embodiment of the techniques presented herein, the method further comprises exiting the power boost mode prior to expiration of the predetermined time period responsive to at least one of a temperature of a charging system including the USB-C/PD port exceeding a predetermined temperature, or detecting a disconnection of the device from the USB-C/PD port.

In an embodiment of the techniques presented herein, entering the power boost mode comprises sending a power boost mode availability message to the device, and entering the power boost mode responsive to receiving a power boost mode request message from the device.

In an embodiment of the techniques presented herein, entering the power boost mode comprises entering the power boost mode responsive to the power boost mode request message if a temperature of a charging system including the USB-C/PD port is less than a predetermined temperature.

In an embodiment of the techniques presented herein, the method further comprises exiting the power boost mode prior to expiration of the predetermined time period responsive to receiving a power boost mode termination message from the device.

In an embodiment of the techniques presented herein, the method further comprises delivering power to the device through the USB-C/PD port according to a third contract negotiated based on the base power delivery profile prior to entering the power boost mode, wherein entering the power boost mode comprises entering the power boost mode responsive to the third contract being based on a highest power delivery option in the base power delivery profile.

In an embodiment of the techniques presented herein, entering the power boost mode comprises entering the power boost mode responsive to a temperature of a charging system including the USB-C/PD port being less than a predetermined temperature.

In an embodiment of the techniques presented herein, the method further comprises exiting the power boost mode prior to expiration of the predetermined time period responsive the temperature of the charging system including the USB-C/PD port exceeding the predetermined temperature.

In an embodiment of the techniques presented herein, a system comprises a USB Type-C Power Delivery (USB-C/PD) port, a controller operatively coupled to the USB-C/PD port, wherein the controller is configured to detect a connection of a device to the USB-C/PD port, generate a base power delivery profile for providing power to the device through the USB-C/PD port according to a base maximum power level, enter a power boost mode, generate a power boost delivery profile in the power boost mode according to a boost maximum power level greater than the base maximum power level, deliver power to the device through the USB-C/PD port according to a first contract negotiated based on the power boost delivery profile for a predetermined time period, exit the power boost mode responsive to expiration of the predetermined time period, and deliver power to the device through the USB-C/PD port according to a second contract negotiated based on the base power delivery profile after exiting the power boost mode, wherein the second contract is compliant with a USB-PD specification.

In an embodiment of the techniques presented herein, the controller is configured to set a boost mode inhibit flag after exiting the power boost mode, and clear the boost mode inhibit flag responsive to detecting a disconnection of the device from the USB-C/PD port.

In an embodiment of the techniques presented herein, the controller is configured to exit the power boost mode prior to expiration of the predetermined time period responsive to at least one of a temperature of a charging system including the USB-C/PD port exceeding a predetermined temperature, or detecting a disconnection of the device from the USB-C/PD port.

In an embodiment of the techniques presented herein, the controller is configured to enter the power boost mode by sending a power boost mode availability message to the device, and entering the power boost mode responsive to receiving a power boost mode request message from the device.

In an embodiment of the techniques presented herein, the controller is configured to enter the power boost mode responsive to receiving the power boost message and a temperature of a charging system including the USB-C/PD port being less than a predetermined temperature.

In an embodiment of the techniques presented herein, the controller is configured to exit the power boost mode prior to expiration of the predetermined time period responsive to receiving a power boost mode termination message from the device.

In an embodiment of the techniques presented herein, the controller is configured to deliver power to the device through the USB-C/PD port according to a third contract negotiated based on the base power delivery profile prior to entering the power boost mode, and enter the power boost mode responsive to the third contract being based on a highest power delivery profile in the base power delivery profile.

In an embodiment of the techniques presented herein, the controller is configured to enter the power boost mode responsive to a temperature of a charging system including the USB-C/PD port being less than a predetermined temperature.

In an embodiment of the techniques presented herein, the controller is configured to exit the power boost mode prior to expiration of the predetermined time period responsive to the temperature of the charging system including the USB-C/PD port exceeding the predetermined temperature.

In an embodiment of the techniques presented herein, a method comprises detecting a connection of a device to a USB Type-C Power Delivery (USB-C/PD) port, generating a base power delivery profile for providing power to the device through the USB-C/PD port according to a base maximum power level, entering a power boost mode, generating a power boost delivery profile in the power boost mode according to a boost maximum power level greater than the base maximum power level, delivering power to the device through the USB-C/PD port according to a first contract negotiated based on the power boost delivery profile, exiting the power boost mode responsive to at least one of an expiration of a predetermined time period, a temperature of a charging system including the USB-C/PD port exceeding a predetermined temperature, or receiving a power boost mode termination message from the device, setting a boost mode inhibit flag after exiting the power boost mode, delivering power to the device through the USB-C/PD port according to a second contract negotiated based on the base power delivery profile after exiting the power boost mode, and clearing the boost mode inhibit flag responsive to detecting a disconnection of the device from the USB-C/PD port, wherein the second contract is compliant with a USB-PD specification.

In an embodiment of the techniques presented herein, entering the power boost mode comprises at least one of entering the power boost mode responsive to receiving a power boost mode request message from the device responsive to a power boost mode supported message sent to the device, entering the power boost mode responsive to a third contract negotiated with the device prior to entering the power boost mode being based on a highest power delivery option in the base power delivery profile, or entering the power boost mode responsive to a temperature of the device connected to the USB-C/PD port being less than a predetermined temperature.

Various operations of embodiments are provided herein. In an embodiment, one or more of the operations described may constitute computer readable instructions (e.g. firmware) stored on one or more computer readable media, which if executed by an electronic device, will cause the device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” and/or the like is used herein to mean serving as an example, instance, illustration, etc., and not necessarily as advantageous. As used herein, “or” is intended to mean an inclusive “or” rather than an exclusive “or”. In addition, “a” and “an” as used in this application can generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
detecting a connection of a device to a USB Type-C Power Delivery (USB-C/PD) port;
generating a base power delivery profile for providing power to the device through the USB-C/PD port according to a base maximum power level;
entering a power boost mode;
generating a power boost delivery profile in the power boost mode according to a boost maximum power level greater than the base maximum power level;
delivering power to the device through the USB-C/PD port according to a first contract negotiated based on the power boost delivery profile for a predetermined time period;
exiting the power boost mode responsive to expiration of the predetermined time period; and
delivering power to the device through the USB-C/PD port according to a second contract negotiated based on the base power delivery profile after exiting the power boost mode, wherein:
the second contract is compliant with a USB-PD specification.

2. The method of claim 1, further comprising:
setting a boost mode inhibit flag after exiting the power boost mode; and
clearing the boost mode inhibit flag responsive to detecting a disconnection of the device from the USB-C/PD port.

3. The method of claim 1, further comprising:
exiting the power boost mode prior to expiration of the predetermined time period responsive to at least one of:
a temperature of a charging system including the USB-C/PD port exceeding a predetermined temperature; or
detecting a disconnection of the device from the USB-C/PD port.

4. The method of claim 1, wherein entering the power boost mode comprises:
sending a power boost mode availability message to the device; and
entering the power boost mode responsive to receiving a power boost mode request message from the device.

5. The method of claim 4, wherein entering the power boost mode comprises:
entering the power boost mode responsive to the power boost mode request message if a temperature of a charging system including the USB-C/PD port is less than a predetermined temperature.

6. The method of claim 4, further comprising:
exiting the power boost mode prior to expiration of the predetermined time period responsive to receiving a power boost mode termination message from the device.

7. The method of claim 1, further comprising:
delivering power to the device through the USB-C/PD port according to a third contract negotiated based on the base power delivery profile prior to entering the power boost mode, wherein
entering the power boost mode comprises entering the power boost mode responsive to the third contract being based on a highest power delivery option in the base power delivery profile.

8. The method of claim 1, wherein entering the power boost mode comprises:
entering the power boost mode responsive to a temperature of a charging system including the USB-C/PD port being less than a predetermined temperature.

9. The method of claim 8, further comprising:
exiting the power boost mode prior to expiration of the predetermined time period responsive the temperature of the charging system including the USB-C/PD port exceeding the predetermined temperature.

10. A system comprising:
a USB Type-C Power Delivery (USB-C/PD) port;
a controller operatively coupled to the USB-C/PD port, wherein the controller is configured to:
detect a connection of a device to the USB-C/PD port;
generate a base power delivery profile for providing power to the device through the USB-C/PD port according to a base maximum power level;
enter a power boost mode;
generate a power boost delivery profile in the power boost mode according to a boost maximum power level greater than the base maximum power level;
deliver power to the device through the USB-C/PD port according to a first contract negotiated based on the power boost delivery profile for a predetermined time period;
exit the power boost mode responsive to expiration of the predetermined time period; and
deliver power to the device through the USB-C/PD port according to a second contract negotiated based on the base power delivery profile after exiting the power boost mode, wherein:
the second contract is compliant with a USB-PD specification.

11. The system of claim 10, wherein the controller is configured to:
set a boost mode inhibit flag after exiting the power boost mode; and
clear the boost mode inhibit flag responsive to detecting a disconnection of the device from the USB-C/PD port.

12. The system of claim 10, wherein the controller is configured to:
exit the power boost mode prior to expiration of the predetermined time period responsive to at least one of:
a temperature of a charging system including the USB-C/PD port exceeding a predetermined temperature; or
detecting a disconnection of the device from the USB-C/PD port.

13. The system of claim 10, wherein the controller is configured to enter the power boost mode by:
sending a power boost mode availability message to the device; and
entering the power boost mode responsive to receiving a power boost mode request message from the device.

14. The system of claim 13, wherein:
the controller is configured to enter the power boost mode responsive to receiving the power boost message and a temperature of a charging system including the USB-C/PD port being less than a predetermined temperature.

15. The system of claim 10, wherein the controller is configured to:
exit the power boost mode prior to expiration of the predetermined time period responsive to receiving a power boost mode termination message from the device.

16. The system of claim 10, wherein the controller is configured to:
deliver power to the device through the USB-C/PD port according to a third contract negotiated based on the base power delivery profile prior to entering the power boost mode; and
enter the power boost mode responsive to the third contract being based on a highest power delivery profile in the base power delivery profile.

17. The system of claim 10, wherein the controller is configured to:
enter the power boost mode responsive to a temperature of a charging system including the USB-C/PD port being less than a predetermined temperature.

18. The system of claim 17, wherein the controller is configured to:
exit the power boost mode prior to expiration of the predetermined time period responsive to the temperature of the charging system including the USB-C/PD port exceeding the predetermined temperature.

19. A method, comprising:
detecting a connection of a device to a USB Type-C Power Delivery (USB-C/PD) port;
generating a base power delivery profile for providing power to the device through the USB-C/PD port according to a base maximum power level;
entering a power boost mode;
generating a power boost delivery profile in the power boost mode according to a boost maximum power level greater than the base maximum power level;
delivering power to the device through the USB-C/PD port according to a first contract negotiated based on the power boost delivery profile;
exiting the power boost mode responsive to at least one of:
an expiration of a predetermined time period;
a temperature of a charging system including the USB-C/PD port exceeding a predetermined temperature; or
receiving a power boost mode termination message from the device;
setting a boost mode inhibit flag after exiting the power boost mode;
delivering power to the device through the USB-C/PD port according to a second contract negotiated based on the base power delivery profile after exiting the power boost mode; and
clearing the boost mode inhibit flag responsive to detecting a disconnection of the device from the USB-C/PD port, wherein:
the second contract is compliant with a USB-PD specification.

20. The method of claim 19, wherein entering the power boost mode comprises at least one of:
entering the power boost mode responsive to receiving a power boost mode request message from the device responsive to a power boost mode supported message sent to the device;
entering the power boost mode responsive to a third contract negotiated with the device prior to entering the power boost mode being based on a highest power delivery option in the base power delivery profile; or
entering the power boost mode responsive to a temperature of the device connected to the USB-C/PD port being less than a predetermined temperature.
